(19) United States
(12) Patent Application Publication
(10) Pub. No.: US 2026/0310578 A1
(43) Pub. Date: Oct. 8, 2026

(54) SYSTEMS AND METHODS FOR DETERMINING AN APPLICATIONS FUNCTIONAL STATE USING ADVANCED COMPUTATIONAL MODELS FOR DATA ANALYSIS AND AUTOMATED PROCESSING

(71) Applicant: BANK OF AMERICA CORPORATION, Charlotte, NC (US)

(72) Inventors: Saurabh Arora, Gurugram (IN); Sandeep Kumar Chauhan, Miyapur (IN)

(73) Assignee: BANK OF AMERICA CORPORATION, Charlotte, NC (US)

(21) Appl. No.: 19/173,187

(22) Filed: Apr. 8, 2025

(51) Int. Cl. G06F 11/3604

(52) U.S. Cl. CPC G06F 11/3612

(57) ABSTRACT

Systems, computer program products, and methods are described herein for determining an application's functional state using advanced computational models for data analysis and automated processing. The present disclosure is configured to receive a transaction including a current state from a plurality of states that an application executes to perform an action. The system extracts metadata and retrieves, from a Single Process Inventory (SPI), a transaction process that corresponds with the transaction and includes an expected state from the plurality of states. The system monitors the transaction as it progresses through the plurality of states to perform the action. The system compares the transaction's actual progression with the expected transaction process. Based on the comparison, the system determines whether a deviation has occurred. If a deviation is identified, the system recommends a corrective action to eliminate the deviation.

### TECHNOLOGICAL FIELD

Example embodiments of the present disclosure relate to systems and methods for determining an application's functional state using advanced computational models for data analysis and automated processing.

### BACKGROUND

There are significant challenges with determining a functional state of an application. Applicant has identified a number of deficiencies and problems associated with conventional procedures for determining an application's functional state. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for determining an application's functional state using advanced computational models for data analysis and automated processing.

Embodiments of the present invention address the above needs and/or achieve other advantages by providing apparatuses (e.g., a system, computer program product, and/or other devices) and methods for determining an application's functional state using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present disclosure provides a solution that may receive a transaction comprising a current state of a plurality of states an application executes to perform an action. In some embodiments, the solution may extract metadata comprising real time details associated with the transaction. In some embodiments, the solution may retrieve, from a Single Process Inventory (SPI), a transaction process that corresponds with the transaction comprising an expected state of the plurality of states the application executes to perform the action. In some embodiments, the solution may monitor the transaction as the transaction completes the plurality of states to perform the action. In some embodiments, the solution may compare the transaction with the transaction process. In some embodiments, the solution may determine a deviation comprising the transaction deviating from the transaction process. In some embodiments, the solution may recommend a corrective action that eliminates the deviation by configuring the transaction to match the transaction process.

In some embodiments, the solution may recommend, via a Generative Artificial Intelligence (GenAI) engine, an update configured to eliminate the deviation for future transactions.

In some embodiments, the update comprises configuring the current state of the plurality of states of the transaction.

In some embodiments, the update comprises configuring the expected state of the plurality of states of the transaction.

In some embodiments, the solution may generate a functional hierarchy of the transaction comprising the current state of the transaction, the application executing the transaction, and any related applications involved in processing the transaction. In some embodiments, the solution may generate a process hierarchy of the transaction process comprising the expected state as defined by the SPI. In some embodiments, the solution may generate, via a GenAI engine, the corrective action comprising at least one of: a code change to the application executing the transaction, or an update to the transaction process to align the process hierarchy with real-time transaction behaviors.

In some embodiments, the solution may transmit the corrective action to an administrator for approval. In some embodiments, the solution may receive approval from the administrator. In some embodiments, the solution may implement the corrective action.

In some embodiments, determining the deviation comprising the transaction deviating from the transaction process is performed by a GenAI engine trained on historical transactions and transaction workflow states.

In some embodiments, recommending the corrective action that eliminates the deviation by configuring the transaction to match the transaction process comprises using a GenAI engine to determine the expected state of the transaction based on the transaction process, and update the expected state of the transaction based on the deviation and the transaction process.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining an application's functional state using advanced computational models for data analysis and automated processing, in accordance with an embodiment of the disclosure;

FIG. 2 illustrates an exemplary generative AI subsystem 200, in accordance with an embodiment of the invention;

FIG. 3 illustrates a process flow for determining an application's functional state using advanced computational models for data analysis and automated processing, in accordance with an embodiment of the disclosure; and

FIG. 4 illustrates an exemplary application state determination system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The present disclosure relates to systems and methods for managing real-time transactional workflows in distributed computing environments. More specifically, the disclosure provides an artificial intelligence (AI)-driven solution, utilizing retrieval-augmented generation (GenAI), to monitor, compare, and correct deviations between live transaction flows and predefined workflows stored in a centralized process inventory (e.g., a single process inventory). The system intelligently analyzes transaction metadata, retrieves associated process expectations, detects anomalies, and proposes or executes corrective actions—resulting in improved transaction integrity, efficiency, and automation across applications.

In conventional systems, real-time transactions often span multiple applications and states. However, there is currently no efficient mechanism to determine whether an in-progress transaction is deviating from its predefined process path. Existing solutions typically require manual monitoring or the like, which is time-consuming, error-prone, and resource-intensive. Additionally, the complexity of managing interdependent applications and workflows at scale makes it difficult to detect and respond to errors in real time, leading to reduced system reliability and increased operational costs.

What is more, the present disclosure provides a technical solution to a technical problem. As described herein, the technical problem includes inability of existing systems to automatically detect and correct deviations between real-time transaction flows and predefined transactional workflows, particularly in environments where such workflows are stored in centralized process inventories. The technical solution presented herein allows for dynamic monitoring of transaction states, real-time comparison against expected workflows retrieved from a Single Process Inventory (SPI), and automated or semi-automated corrective action generation using a Generative Artificial Intelligence (GenAI) engine. In particular, the process hierarchy based on the SPI is an improvement over existing solutions to the problem of maintaining transactions across distributed applications, (i) with fewer steps to achieve the solution, thus reducing the amount of computing resources, such as processing resources, storage resources, network resources, and/or the like, that are being used (e.g., eliminating the need for manual intervention or retrospective log analysis to determine process violations), (ii) providing a more accurate solution to problem, thus reducing the number of resources required to remedy any errors made due to a less accurate solution (e.g., avoiding improper transaction reversals or redundant workflow executions), (iii) removing manual input and waste from the implementation of the solution, thus improving speed and efficiency of the process and conserving computing resources (e.g., reducing manual involvement in diagnosing and updating workflows), (iv) determining an optimal amount of resources that need to be used to implement the solution, thus reducing network traffic and load on existing computing resources (e.g., applying recommendations only to impacted workflow components instead of reprocessing full transactions). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the application state determination system as described herein is a solution to the problem of detecting and correcting real-time deviations in transactional workflows as they occur, using predefined workflows stored in a single process inventory. Further, the application state determination system may be characterized as identifying a specific improvement in computer capabilities and/or network functionalities in response to the application state determination system's integration to existing devices, software, applications, and/or the like. In this way, the application state determination system improves the capability of a system to dynamically monitor transaction progress, determine its current functional state across multiple applications, compare that state against an expected process hierarchy, and execute or recommend corrective actions using artificial intelligence. Further, the application state determination system improves the functionality of networks in response to reducing the resources consumed by the system (e.g., network resources, computing resources, memory resources, and/or the like).

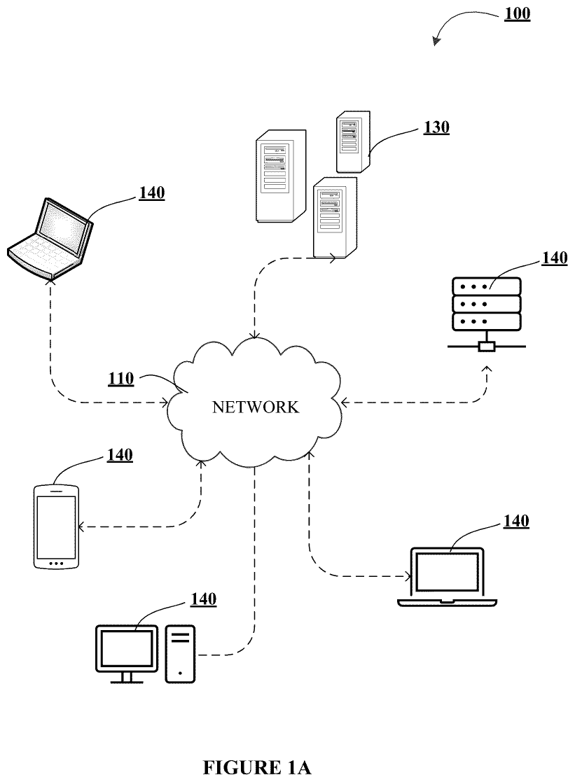

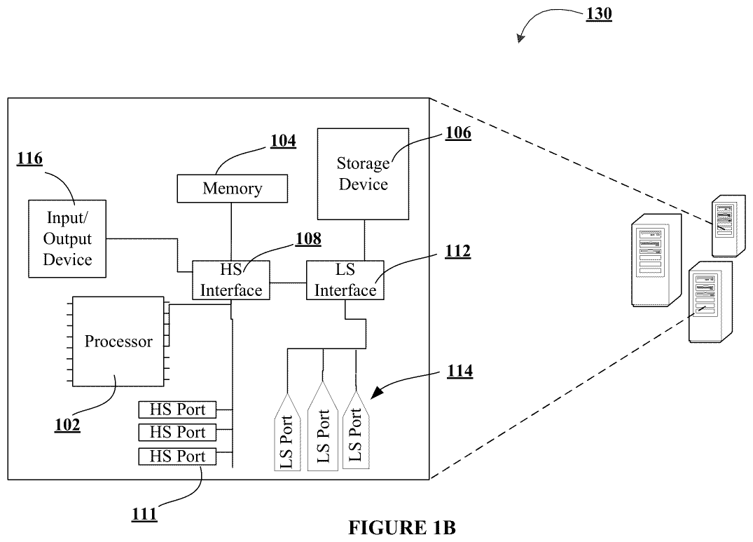

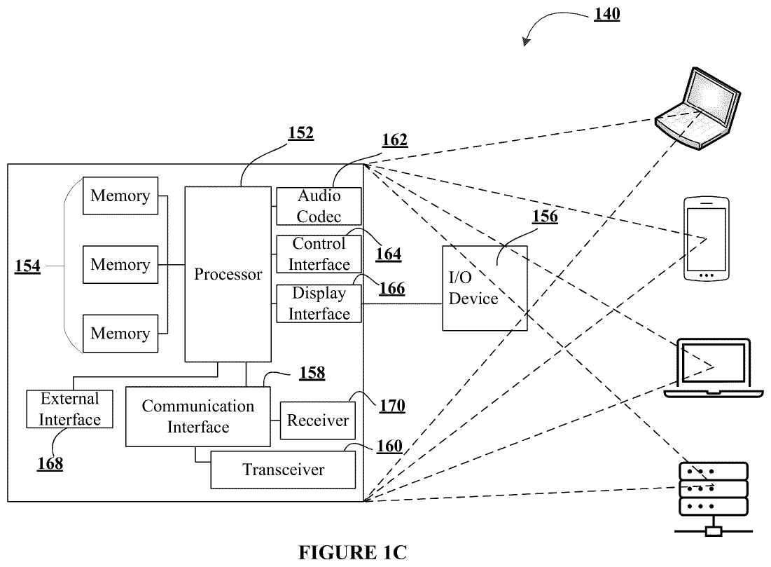

FIGS. 1A-1C illustrate technical components of an exemplary distributed computing environment 100 for determining an application's functional state using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

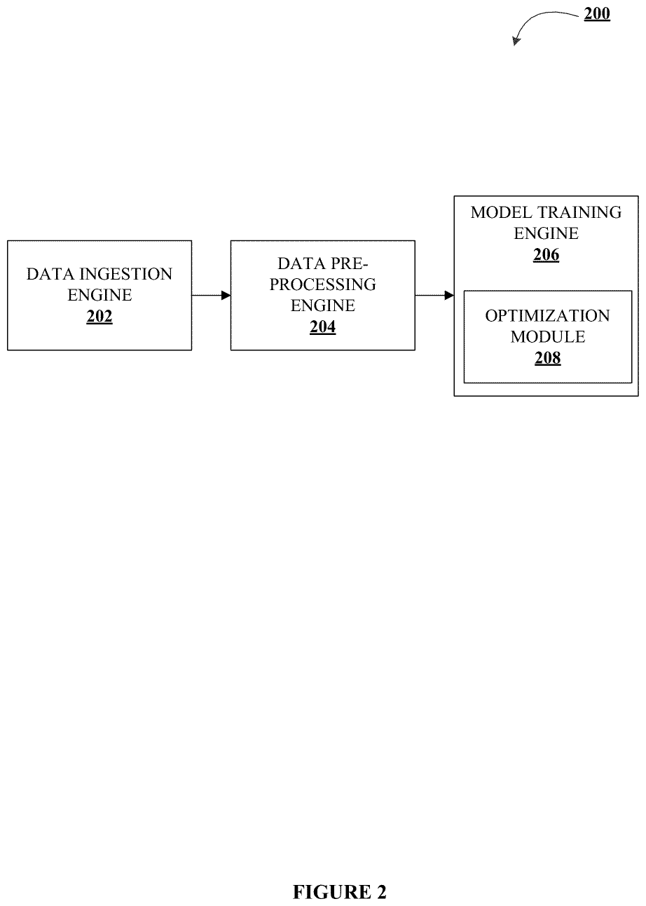

FIG. 2 illustrates an exemplary generative AI subsystem 200, in accordance with an embodiment of the invention. The generative AI subsystem 200 may include a data ingestion engine 202, a data pre-processing engine 204, and a model training engine 206. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 202 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 200 may utilize one or more machine learning techniques to generate new content. In machine learning, the quality of data and the useful information that may be derived therefrom directly affects the ability of the machine learning model to learn. The data pre-processing engine 204 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that may be suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training engine 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data may be used to update the model's parameters, while the validation and testing datasets may be reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206, which includes an optimization module 208, may implement various optimization techniques to improve model performance and efficiency. The optimization module 208 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 208 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

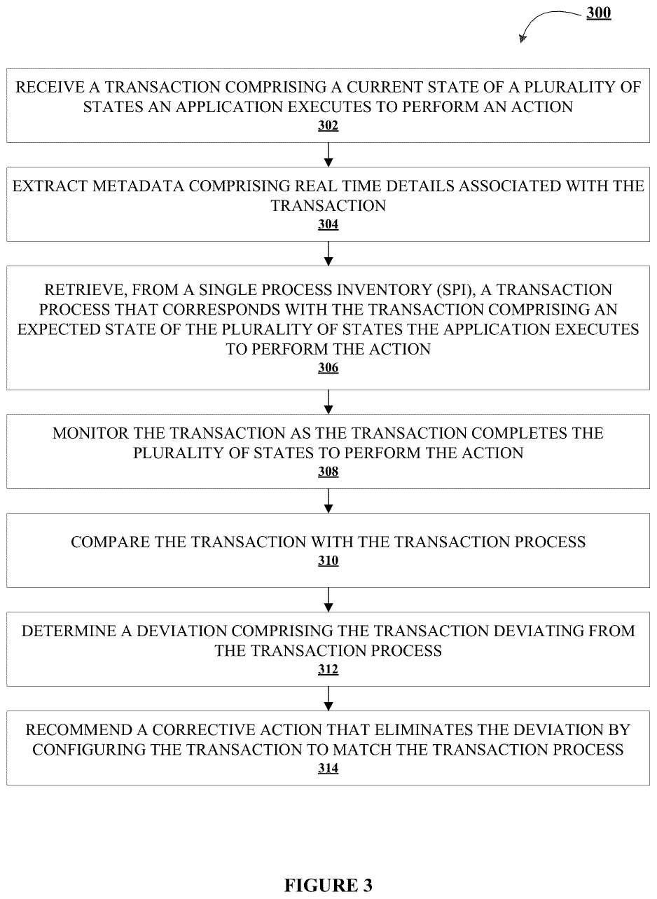

FIG. 3 illustrates a process flow for determining an application's functional state using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an application state determination system (e.g., similar to one or more of the systems described herein with respect to FIGS. 1A-1C) may perform one or more of the steps of process flow 300. For example, an application state determination system (e.g., the system 130 described herein with respect to FIGS. 1A-1C) may perform the steps of process flow 300.

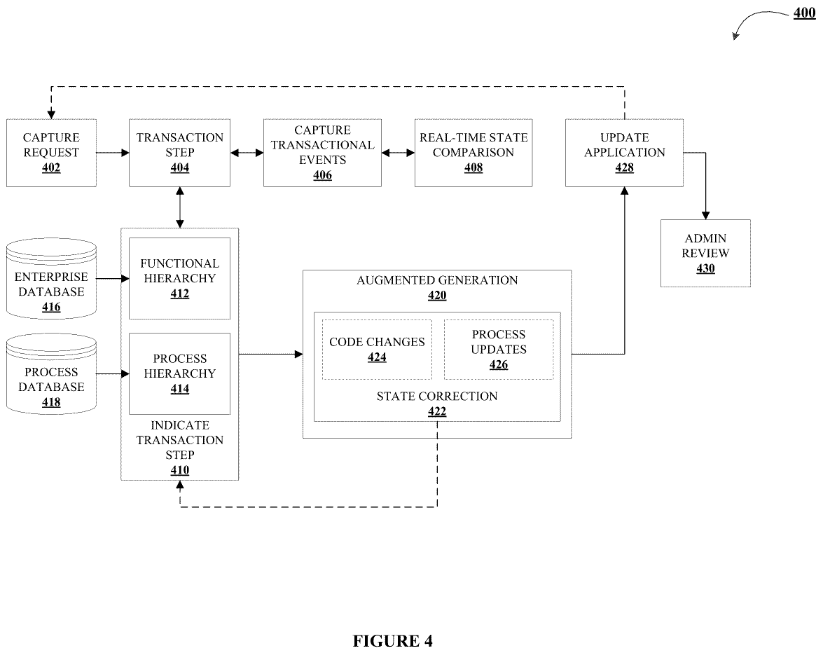

As shown in block 302, the process flow 300 of this embodiment includes receiving a transaction including a current state of a plurality of states an application executes to perform an action. As used herein, the “transaction” may represent any action, request, or workflow initiated within an enterprise system—for example, a funds transfer, a credit decision, or a payment authorization—which involves movement through several discrete operational states. Each of these states may be part of a larger workflow that spans one or more applications within a distributed computing environment. For example, as shown in block 402 of FIG. 4, the system may capture a request. In some embodiments, this may include capturing the request via an API, monitoring an event stream, receiving a message, or the like.

In some embodiments, the transaction's state information may be analyzed in real time by the application state determination system to understand how far the transaction has progressed within its expected workflow, which may be defined in a centralized repository referred to as the Single Process Inventory (SPI). In some embodiments, the received transaction data may also include relationships to other concurrently running transactions or subprocesses, allowing the system to construct a functional hierarchy representing not only the state of the primary transaction but also the status and involvement of any supporting applications or systems. For example, transaction step 404 in FIG. 4 may include mapping real time transaction steps to one or more hierarchies, as will be discussed later.

As shown in block 304, the process flow 300 of this embodiment includes extracting metadata including real time details associated with the transaction. The metadata may include information such as timestamps, transaction identifiers, user or system initiators, execution environment details, and the status of related processes or sub-transactions. For example, the system may capture transaction events, as shown in block 406 of FIG. 4, which may include extracting the metadata associated with the transaction. In some embodiments, the metadata may also include logs, event data, API data, and resource usage metrics captured during the transaction's progression through its current application state. Further, the metadata may provide information associated with the transaction's context for the system to evaluate its alignment with expected behavior. For example, the timing and sequence of state transitions may be compared to determine if the appropriate states were invoked.

As shown in block 306, the process flow 300 of this embodiment includes retrieving, from a single process inventory (SPI), a transaction process that corresponds with the transaction including an expected state of the plurality of states the application executes to perform the action. In some embodiments, the SPI may serve as a centralized repository that stores predefined transaction workflows for various types of application processes. For example, a process database 418, as shown in FIG. 4, may include the SPI. In this regard, the SPI may be stored in the process database 418. Each transaction process stored in the SPI may define an ordered set of expected states or steps that a transaction of a particular type is intended to follow from initiation to completion.

In some embodiments, the retrieval of the transaction process may be based on identifying characteristics of the transaction (e.g., a transaction type identifier, application context, metadata, etc.). For example, the system may determine an indication of the transaction step 410 as shown in FIG. 4. In this regard, the specific state of the transaction (e.g., the transaction step) may be indicated with respect to the real-time state which may be noted in the functional hierarchy 412 and the expected state as noted in the process hierarch 414. The system may then access the database(s) (e.g., enterprise database 416 and process database 418) based on the indicated transaction step 410. Further, in some embodiments, once matched, the system may retrieve the corresponding transaction process from the SPI, which may include structural and behavioral definitions of the expected execution path. The expected path may be represented as a sequence of states, transitions, dependencies, and any conditions that govern movement between states.

As shown in block 308, the process flow 300 of this embodiment includes monitoring the transaction as the transaction completes the plurality of states to perform the action. In some embodiments, monitoring may involve observing the progression of the transaction through its defined execution path, as specified in the corresponding transaction process retrieved from the SPI. For example, each state of the transaction may represent a discrete operational step performed by one or more applications or system components. In some embodiments, the system may monitor or track the transaction in real time or near real time by receiving updates from application logs, event streams, middleware systems, direct monitoring systems, or the like. Further, monitoring the transaction may be continuous or may be triggered by certain events.

As shown in block 310, the process flow 300 of this embodiment includes comparing the transaction with the transaction process. In some embodiments, the comparison may involve evaluating the real-time execution path of the transaction (e.g., the current state) against the expected sequence of states (e.g., the expected state) retrieved from the SPI. In some embodiments, the comparison may be performed by aligning the functional hierarchy of the transaction with the process hierarchy associated with the expected workflow. For example, the real-time state comparison 408 of FIG. 4 may include the comparison of the functional hierarchy 412 and the process hierarchy 414. Further, the comparison may include assessing the order and timing of transaction states, determining involvement of other systems, identification of missing steps, or the like. Further, in some embodiments, the comparison may include evaluating the transaction metadata (e.g., timestamps, identifiers, error codes, or the like) against expected values or thresholds as defined in the transaction process.

As shown in block 312, the process flow 300 of this embodiment includes determining a deviation including the transaction deviating from the transaction process. In some embodiments, determining the deviation including the transaction deviating from the transaction process may be performed by a GenAI engine trained on historical transaction and transaction workflow states. In some embodiments, a deviation may occur when the transaction (e.g., the real-time execution) does not align with the transaction process (e.g., the predefined process) as retrieved from the SPI. For example, the deviation may include differences in the sequence of executed states, the involvement of unexpected applications, missing or repeated steps, or the occurrence of errors that are not anticipated by the process definition.

In some embodiments, the system may include recommending, via the GenAI engine, an update configured to eliminate the deviation for future transactions. In some embodiments, the recommendation may be based on the identified cause of the deviation, historical data, or patterns in similar transactions. For example, the augmented generation 420 as shown in FIG. 4 may be performed by the GenAI engine. Further, the update may align future transactions more closely with the intended process or to configure the transaction process definition to reflect real-world behavior.

In some embodiments, the update may include configuring the current state of the plurality of states of the transaction (e.g., state correction 422 as shown in FIG. 4). For example, the update may involve adjusting the transaction's position within its process path, re-executing a missed step, or transitioning it to an appropriate state based on the expected workflow. In some embodiments, the update may include configuring the expected state of the plurality of states of the transaction. For example, the update may involve modifying the transaction process stored in the SPI to better reflect observed and validated transaction behavior, including the sequence or conditions associated with specific states.

As shown in block 314, the process flow 300 of this embodiment includes recommending a corrective action that eliminates the deviation by configuring the transaction to match the transaction process. In some embodiments, the corrective action may be determined based on the specific point and nature of the deviation identified during the comparison step. For example, the corrective action may include proposing adjustments to the current state of the transaction so that it conforms to the expected state sequence defined in the transaction process retrieved from the Single Process Inventory (SPI). The recommended action may be configured to return the transaction to a compliant state or allow it to continue along a valid path, depending on the process structure and system constraints. In some embodiments, the corrective action may be applied immediately or reviewed by an administrator prior to execution.

In some embodiments, recommending the corrective action that eliminates the deviation by configuring the transaction to match the transaction process may include using the GenAI engine to determine the expected state of the transaction based on the transaction process and update the expected state of the transaction based on the deviation and the transaction process. In some embodiments, the GenAI engine may evaluate the transaction's current status, identify the most appropriate point of re-entry or adjustment within the defined workflow, and generate a recommended update. For example, the GenAI recommendation may include resuming execution at a missed step, bypassing an invalid state, or amending metadata associated with the transaction to reflect an aligned position within the process. The recommendation may also take into account patterns observed in similar past transactions to improve the relevance and effectiveness of the proposed correction.

In some embodiments, the system may generate a functional hierarchy of the transaction comprising the current state of the transaction, the application executing the transaction, and any related applications involved in processing the transaction. In some embodiments, the functional hierarchy may represent a view of the transaction's real-time execution path. For example, the functional hierarchy may include details which components are currently active, the specific transaction state being executed, and how supporting applications or services are participating in the workflow. In some embodiments, the hierarchical representation may assist in contextualizing the transaction's behavior within the broader system landscape, enabling more informed analysis of deviations and their potential cause.

In some embodiments, the system may generate a process hierarchy of the transaction process comprising the expected state as defined by the SPI. In some embodiments, the process hierarchy may reflect the ideal or predefined workflow, detailing the logical sequence of states that the transaction is expected to follow. For example, the process hierarchy may also include dependencies, transitions, and any branching conditions or checkpoints included in the SPI. Further, the process hierarchy may serve as the reference model against which the functional hierarchy is compared.

In some embodiments, the system may generate, via a GenAI engine, the corrective action comprising at least one of: a code change to the application executing the transaction, or a process update to the transaction process to align the process hierarchy with real-time transaction behaviors. In some embodiments, the GenAI engine may analyze the deviation between the functional and process hierarchies to determine whether the discrepancy results from an issue within the application logic or an outdated or incomplete process definition. For example, if the deviation is attributed to application behavior, the GenAI engine may generate a proposed code change 424 to address the issue. In another example, if the transaction is behaving consistently but not in alignment with the predefined workflow, the engine may instead propose a process update 426 to the SPI to reflect the current operational reality. In some embodiments, the corrective actions may be submitted for approval or applied automatically depending on system configuration.

In some embodiments, the system may transmit the corrective action to an administrator for approval (e.g., as shown in administrator review 430 of FIG. 4). In some embodiments, the transmission may include details associated with the deviation, the corrective action, and any other supporting information. In some embodiments, the administrator may be able to approve, modify, reject, or otherwise review the proposed action.

In some embodiments, the system may receive an approval from the administrator. In some embodiments, the system may implement the corrective action. In some embodiments, the approval may be captured through a user device of the administrator, a workflow management tool, or other system integrations. Upon approval, the system may prepare to execute the corrective actions as reviewed and approved by the administrator. For example, the application may be updated (e.g., block 428 in FIG. 4) with the approved corrective action. Further, in some embodiments, the execution of such corrective actions may be based upon internal governance protocols or available operation resources.

In some embodiments, the system may implement the corrective action. The implementation may vary based on the nature of the corrective action. For example, if the action involves modifying the current transaction state, the system may update the relevant execution path and/or metadata associated with the transaction. In another example, if the corrective action involves a code change, the system may apply the changes to the appropriate application. In some embodiments, the implementation may occur immediately or during designated deployment timeframes. In some embodiments, the updated application may be analyzed by the application state determination system by capturing the updated state as a request (e.g., capture request 402).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining an application's functional state using advanced computational models for data analysis and automated processing, the system comprising:
a processing device;
a non-transitory storage device containing instructions when executed by the processing device, causes the processing device to perform the steps of:
receive a transaction comprising a current state of a plurality of states an application executes to perform an action;
extract metadata comprising real time details associated with the transaction;
retrieve, from a Single Process Inventory (SPI), a transaction process that corresponds with the transaction comprising an expected state of the plurality of states the application executes to perform the action;
monitor the transaction as the transaction completes the plurality of states to perform the action;
compare the transaction with the transaction process;
determine a deviation comprising the transaction deviating from the transaction process; and
recommend a corrective action that eliminates the deviation by configuring the transaction to match the transaction process.

2. The system of claim 1, wherein executing the instructions further causes the processing device to recommend, via a Generative Artificial Intelligence (GenAI) engine, an update configured to eliminate the deviation for future transactions.

3. The system of claim 2, wherein the update comprises configuring the current state of the plurality of states of the transaction.

4. The system of claim 2, wherein the update comprises configuring the expected state of the plurality of states of the transaction.

5. The system of claim 1, wherein executing the instructions further causes the processing device to:
generate a functional hierarchy of the transaction comprising the current state of the transaction, the application executing the transaction, and any related applications involved in processing the transaction;
generate a process hierarchy of the transaction process comprising the expected state as defined by the SPI; and
generate, via a GenAI engine, the corrective action comprising at least one of:
a code change to the application executing the transaction; or
a process update to the transaction process to align the process hierarchy with real-time transaction behaviors.

6. The system of claim 5, wherein executing the instructions further causes the processing device to:
transmit the corrective action to an administrator for approval;
receive approval from the administrator; and
implement the corrective action.

7. The system of claim 1, wherein determining the deviation comprising the transaction deviating from the transaction process is performed by a GenAI engine trained on historical transactions and transaction workflow states.

8. The system of claim 1, wherein recommending the corrective action that eliminates the deviation by configuring the transaction to match the transaction process comprises using a GenAI engine to:
determine the expected state of the transaction based on the transaction process; and
update the expected state of the transaction based on the deviation and the transaction process.

9. A computer program product for determining an application's functional state using advanced computational models for data analysis and automated processing, the computer program product comprising a non-transitory computer-readable medium comprising code causing an apparatus to:
receive a transaction comprising a current state of a plurality of states an application executes to perform an action;
extract metadata comprising real time details associated with the transaction;
retrieve, from a Single Process Inventory (SPI), a transaction process that corresponds with the transaction comprising an expected state of the plurality of states the application executes to perform the action;
monitor the transaction as the transaction completes the plurality of states to perform the action;
compare the transaction with the transaction process;
determine a deviation comprising the transaction deviating from the transaction process; and
recommend a corrective action that eliminates the deviation by configuring the transaction to match the transaction process.

10. The computer program product of claim 9, wherein the code further causes the apparatus to recommend, via a Generative Artificial Intelligence (GenAI) engine, an update configured to eliminate the deviation for future transactions.

11. The computer program product of claim 10, wherein the update comprises configuring the current state of the plurality of states of the transaction.

12. The computer program product of claim 10, wherein the update comprises configuring the expected state of the plurality of states of the transaction.

13. The computer program product of claim 9, wherein the code further causes the apparatus to:
generate a functional hierarchy of the transaction comprising the current state of the transaction, the application executing the transaction, and any related applications involved in processing the transaction;
generate a process hierarchy of the transaction process comprising the expected state as defined by the SPI; and
generate, via a GenAI engine, the corrective action comprising at least one of:
a code change to the application executing the transaction; or
a process update to the transaction process to align the process hierarchy with real-time transaction behaviors.

14. The computer program product of claim 13, wherein the code further causes the apparatus to:
transmit the corrective action to an administrator for approval;
receive approval from the administrator; and
implement the corrective action.

15. The computer program product of claim 9, wherein determining the deviation comprising the transaction deviating from the transaction process is performed by a GenAI engine trained on historical transactions and transaction workflow states.

16. The computer program product of claim 9, wherein recommending the corrective action that eliminates the deviation by configuring the transaction to match the transaction process comprises using a GenAI engine to:
determine the expected state of the transaction based on the transaction process; and
update the expected state of the transaction based on the deviation and the transaction process.

17. A method for determining an application's functional state using advanced computational models for data analysis and automated processing, the method comprising:
receiving a transaction comprising a current state of a plurality of states an application executes to perform an action;
extracting metadata comprising real time details associated with the transaction;
retrieving, from a Single Process Inventory (SPI), a transaction process that corresponds with the transaction comprising an expected state of the plurality of states the application executes to perform the action;
monitoring the transaction as the transaction completes the plurality of states to perform the action;
comparing the transaction with the transaction process;
determining a deviation comprising the transaction deviating from the transaction process; and
recommending a corrective action that eliminates the deviation by configuring the transaction to match the transaction process.

18. The method of claim 17, wherein the method further comprises recommending, via a Generative Artificial Intelligence (GenAI) engine, an update configured to eliminate the deviation for future transactions.

19. The method of claim 18, wherein the update comprises configuring the current state of the plurality of states of the transaction.

20. The method of claim 18, wherein the update comprises configuring the expected state of the plurality of states of the transaction.
